(19) United States
(12) Patent Application Publication
(10) Pub. No.: US 2014/0204191 A1
(43) Pub. Date: Jul. 24, 2014

(54) IMAGE DISPLAY DEVICE AND IMAGE DISPLAY METHOD

(71) Applicant: SONY CORPORATION, Tokyo (JP)

(72) Inventors: MOTOYUKI TAKAI, Tokyo (JP); YOICHIRO SAKO, Tokyo (JP); MASASHI TAKEDA, Tokyo (JP); YASUSHI MIYAJIMA, Kanagawa (JP)

(73) Assignee: SONY CORPORATION, Tokyo (JP)

(21) Appl. No.: 14/151,128

(22) Filed: Jan. 9, 2014

(30) Foreign Application Priority Data
Jan. 21, 2013 (JP) 2013-008050

(51) Int. Cl. G02B 27/01; G06K 9/00

(52) U.S. Cl. CPC G02B 27/0172; G06K 9/0008; G06K 9/00281
USPC 348/77; 345/8

(57) ABSTRACT

An image display device which is used by being mounted on the head or a face includes an image display unit which displays an image; an image input unit which inputs an image; a judging unit which judges an image which is input to the image input unit, or obtains a judging result with respect to the input image; and a control unit which controls the image display unit based on the judging result of the judging unit.

### CROSS REFERENCE TO RELATED APPLICATIONS

This application claims the benefit of Japanese Priority Patent Application JP 2013-008050 filed Jan. 21, 2013, the entire contents of which are incorporated herein by reference.

### BACKGROUND

The present technology which is disclosed in the specification relates to an image display device which is used by being mounted on the head or a face of a user, and an image display method thereof, and relates to an image display device which displays a result which is estimated or diagnosed with respect to a target in a field of vision of a user, for example, and an image display method thereof.

“Fortune-telling” which estimates or diagnoses human nature or fortune of a person based on shapes, sizes, or color (biological information) of visible parts of the person such as a face, ears, hands, nails, has been familiar for a long time. For example, chirognomy is popular since chirognomy can tell a character or fortune which appears on a plurality of types of palm lines such as a line of life, a line of fate, an intelligence line, a feelings line, or a marriage line which is formed on the palm.

The palm line itself is visual biological information which can be easily extracted by viewing even by an amateur. Among a plurality of types of fortune-telling, popularity of palmistry is high. However, there is a case in which it is difficult for an amateur to read somebody's palm since there is much information, for example, each palm line has different meanings of a character or fortune, two or more palm lines should be judged by being correlated with each other, or the like.

For example, a palmistry system in which an image of palm lines which is transmitted from a mobile terminal with a camera through a network is received, palm lines data is extracted from the received image of the palm lines, fortune-telling data which denotes a result of fortune-telling is obtained based on the extracted palm lines data, and the data is transmitted to the mobile terminal with the camera has been proposed (for example, refer to Japanese Unexamined Patent Application Publication No. 2007-183). The palmistry system can provide palmistry in circumstances in which a computer is not available.

However, fortune-telling data which is correlated with palm line data is simply returned to a mobile terminal. For this reason, it is difficult for a user to visually recognize which one of the plurality of palm lines of himself becomes grounds of the fortune-telling data (on palm in field of vision at that time).

In addition, a target characteristic line specification device which accurately specifies a target characteristic line, or the like, in an image of palm lines has been proposed (for example, refer to Japanese Unexamined Patent Application Publication No. 2010-123020). For example, an information output device can perform palmistry by comparing target characteristic line data which is specified by the target characteristic line specification device to a plurality of palm line data items which are obtained from a database, specifying palm line data which denotes a palm line which is closest to the target characteristic line, and outputting palm line data which is correlated with the specified palm line data.

However, palm line data which is output from an information output device is data of a text format in which contents such as fortune of a person (fortune in marriage, fortune in love, fortune in work, fortune in money, or the like) which is judged by a palmist, or the like, in advance, and talents, and health conditions (good or bad), are defined based on types, shapes, the length, and positional relationships of palm lines. That is, a user is not able to visually recognize which one of the plurality of palm lines of himself becomes grounds of the palmistry data (on palm in field of vision of himself).

In addition, there is an opinion that each palm of the left and right hands has a different meaning of palm lines (for example, there is opinion that palm lines on a person's dominant hand tell acquired talent or future of the person, and palm lines on the other hand tells inborn talent or past of the person). For this reason, preferably, it is necessary to read palm lines on both hands in the palmistry. In the system in which an image of palm lines is photographed using the mobile terminal with camera, it takes twice the labor since a user should perform operations of photographing and transmitting of images of respective left and right hands while having a camera.

### SUMMARY

It is desirable to provide an excellent image display device which can preferably display a result which is estimated or diagnosed with respect to a target in a field of vision of a user, and an image display method thereof.

It is desirable to further provide an image display device which can visually display a result which is estimated or diagnosed based on an image of a specified portion on a body of a person, for example, and an image display method thereof.

According to an embodiment of the present technology, an image display device which is used by being mounted on the head or a face includes an image display unit which displays an image; an image input unit which inputs an image; a judging unit which judges an image which is input to the image input unit, or obtains a judging result with respect to the input image; and a control unit which controls the image display unit based on the judging result of the judging unit.

The image display device according to the embodiment may further include a camera. In addition, the image input unit may be configured so as to input an image which is photographed by the camera.

In the image display device according to the embodiment, the camera may be configured so as to photograph a gaze direction of a user, or at least a part of a body of the user.

The image display device according to the embodiment may further include a storage unit which stores an image. In addition, the image input unit may be configured so as to input an image which is read out from the storage unit.

The image display device according to the embodiment may further include a communication unit which communicates with an external device. In addition, the image input unit may be configured so as to input an image which is obtained from the external device through the communication unit.

In the image display device according to the embodiment, the image display unit may display the image in a see-through mode, the image input unit may input a photographed image in which the gaze direction of a user is photographed using a camera, the judging unit may judge a specified portion in the photographed image, and the control unit may display the judging result on the image display unit so that the judging result is overlapped with the specified portion on a field of vision of the user.

In the image display device according to the embodiment, the image display unit may display the photographed image in which the gaze direction of the user is photographed using the camera, the image input unit may input the photographed image, the judging unit may judge the specified portion in the photographed image, and the control unit may display the judging result by overlapping the result with the specified portion in the photographed image.

The image display device according to the embodiment may further include a storage unit which stores a judging result of the judging unit, or an image which is controlled based on the judging result.

In the image display device according to the embodiment, the judging unit may perform a diagnosis based on characteristics of the specified portion in the input image, and the control unit may display a result of the diagnosis by overlapping the result with a location corresponding to the specified portion in an image which is displayed by the image display unit.

In the image display device according to the embodiment, the judging unit may perform palm reading with respect to palm lines on a palm which is included in the input image, and the control unit may display a result of the palm reading by overlapping the result with a location corresponding to the palm lines in an image which is displayed by the image display unit.

The image display device according to the embodiment may further include a feature amount extraction unit which extracts palm lines from a palm which is included in the input image, and the judging unit may perform palm reading based on the palm lines which are extracted by the feature amount extraction unit.

In the image display device according to the embodiment, the control unit may be configured so as to display the palm lines which are extracted by the feature amount extraction unit by overlapping the palm lines with an image which is displayed by the image display unit.

In the image display device according to the embodiment, the image input unit of the image display device may input an image including the left and right palms, and the judging unit may perform palm reading on the left and right palms from the input image.

The image display device according to the embodiment may further include the feature amount extraction unit which extracts palm lines from a palm which is included in the input image, and the control unit may display the palm lines which are extracted from one of the left and right palms by overlapping the palm lines with palm lines on the other palm, by inverting the palm lines from left to right.

In the image display device according to the embodiment, the judging unit may diagnose a palm hill of a base of at least one finger of a hand which is included in the input image, and the control unit may display a result of the diagnosis by overlapping the result with a location corresponding to the palm hill in an image which is displayed by the image display unit.

In the image display device according to the embodiment, the judging unit may diagnose length of at least one finger of the hand which is included in the input image, and the control unit may display a result of the diagnosis by overlapping the result with a corresponding finger in an image which is displayed by the image display unit.

In the image display device according to the embodiment, the judging unit may perform face reading with respect to a face image which is included in the input image, and the control unit may display a result of the face reading by overlapping the result with a location which becomes grounds of the face reading in an image which is displayed by the image input unit.

In the image display device according to the embodiment, the judging unit may perform a skin diagnosis with respect to the face image which is included in the input image, and the control unit may display a result of the skin diagnosis by overlapping the result with a location which becomes grounds of the skin diagnosis in an image which is displayed by the image display unit.

In the image display device according to the embodiment, the judging unit may specify a position of an acupuncture point from a body of a person which is included in the input photographed image, and the control unit may display the specified position of the acupuncture point by overlapping the position with a corresponding location in an image which is displayed by the image display unit.

According to another embodiment of the present technology, there is provided an image display method which displays an image in an image display device which is used by being mounted on the head or a face, and the method includes inputting of an image; judging an image which is input in the inputting of the image, or obtaining a judging result with respect to the input image; and controlling an image to be displayed based on the judging result of the judging.

According to the embodiment of the present technology which is disclosed in the specification, since a result which is estimated or diagnosed with respect to a target in a field of vision of a user is displayed by being overlapped with the field of vision of the user, the user can easily understand grounds of the result which is estimated or diagnosed.

In addition, according to the embodiment of the present technology which is disclosed in the specification, since a result which is estimated or diagnosed based on an image of a specified portion of a body of a person is displayed by being overlapped with a field of vision in which the portion is viewed, a user can easily understand grounds of the result which is estimated or diagnosed.

Further another object, characteristic, or advantage of the technology which is disclosed in the specification will be clarified by detailed descriptions based on embodiments which will be described later, or accompanying drawings.

### BRIEF DESCRIPTION OF THE DRAWINGS

FIG. 1 is a diagram which illustrates a state in which a user who is wearing a transmission-type head-mounted image display device is viewed from the front;

FIG. 2 is a diagram which illustrates a state in which the user who is wearing a transmission-type head-mounted image display device is viewed from the top;

FIG. 3 is a diagram which illustrates a state in which a user who is wearing a light blocking-type head-mounted image display device is viewed from the front;

FIG. 4 is a diagram which illustrates a state in which a user who is wearing a light blocking-type head-mounted image display device is viewed from the top;

FIG. 5 is a diagram which illustrates an internal configuration example of an image display device;

FIG. 6 is a diagram which schematically illustrates a functional configuration of the image display device for displaying a result which is estimated or diagnosed with respect to a target in a field of vision of a user;

FIG. 7 is a flowchart which illustrates a processing order of the image display device for displaying the result which is estimated or diagnosed with respect to the target in the field of vision of the user;

FIG. 8 is a diagram which exemplifies an image of a palm which is input by an image input unit;

FIG. 9 is a diagram which illustrates a state in which palm lines are displayed by being overlapped with a palm;

FIG. 10 is a diagram which illustrates a state in which a result of palm reading is displayed by being overlapped with a palm, by being correlated with palm lines;

FIG. 11 is a diagram which exemplifies an image in which left and right palms of a user are input at the same time by the image input unit;

FIG. 12 is a diagram which illustrates a state in which each palm line is displayed by being overlapped with the left and right palms;

FIG. 13 is a diagram which illustrates a state in which results of palm reading on the left and right palms are displayed by being correlated with respective palm lines on the left and right palms;

FIG. 14 is a diagram which illustrates a state in which palm lines on the right hand which are inverted from left to right are displayed by being overlapped with palm lines on the left hand;

FIG. 15 is a diagram which illustrates a state in which a contour line denoting a palm hill of the base of each finger is displayed by being overlapped with a palm;

FIG. 16 is a diagram which illustrates a state in which a diagnosis result based on a palm hill is displayed by being overlapped with a palm, by being correlated with a contour line denoting the palm hill;

FIG. 17 is a diagram which illustrates a state in which virtual fingers denoting the length which becomes the standard of each finger are displayed by being overlapped with a palm;

FIG. 18 is a diagram which illustrates a state in which a diagnosis result based on the length of a finger is displayed by being overlapped with a palm;

FIG. 19 is a diagram which exemplifies a face image including a nose which is input using an internal camera, or an external camera by the image input unit;

FIG. 20 is a diagram which illustrates a state in which an image of a virtual nose which has a size, height, a shape, or the like, as standards is displayed by being overlapped with an input face image;

FIG. 21 is a diagram which illustrates a state in which a result of face reading using a size of the whole nose, the height of the nose, color of the nose, a shape of a tip of the nose, nostrils and a vertical groove thereof, and the like, is displayed by being overlapped with a face image;

FIG. 22 is a diagram which illustrates a state in which a result of a fair skin diagnosis is displayed by being overlapped with a face image;

FIG. 23 is a diagram which exemplifies an image of the sole of the foot of a user himself in a field of vision of the user who is wearing the image display device;

FIG. 24 is a diagram which illustrates a state in which a position of a foot acupuncture point on a foot acupuncture point chart is subject to a projection conversion on the sole of the foot on a field of vision of the user; and

FIG. 25 is a diagram which illustrates a state in which the position of the foot acupuncture point is displayed by being overlapped with an image of the original sole of the foot.

### DETAILED DESCRIPTION OF EMBODIMENTS

Hereinafter, embodiments of the technology which will be disclosed in the specification will be described in detail with reference to drawings.

A. Configuration of Device

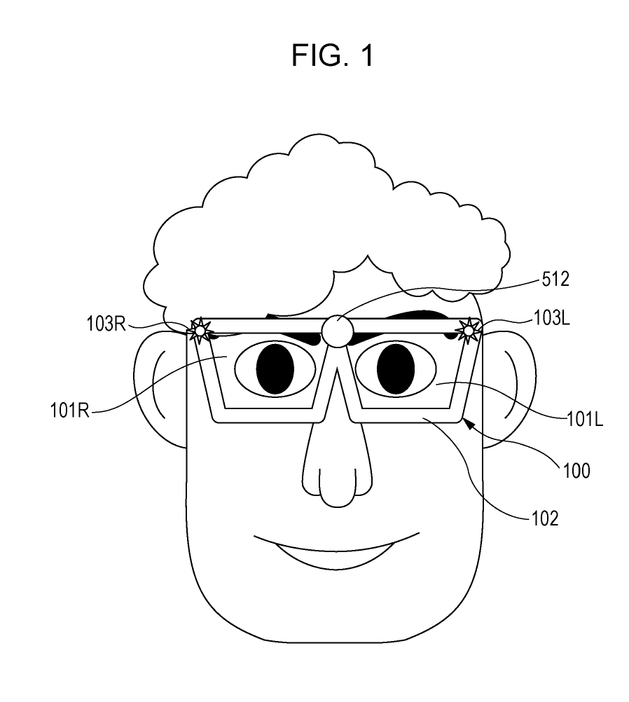

FIG. 1 illustrates an external configuration of an image display device 100 according to one embodiment of the technology which will be disclosed in the specification. The image display device 100 is used by being mounted on the head or a face of a user, and displays an image in each of the left and right eyes. The illustrated image display device 100 is a transmission type, that is, a see-through type, and a user is able to view scenery in a real world over an image (that is, sees through) while the device is displaying the image. Accordingly, it is possible to show a virtual display image by overlapping the image with the scenery in the real world (for example, refer to Japanese Unexamined Patent Application Publication No. 2011-2753). Since the display image is not viewed from the outside (that is, another person), it is possible to easily protect a privacy when displaying information.

The image display device 100 can be used when displaying a result which is estimated or diagnosed with respect to a target in a field of vision of a user, however, this point will be described in detail later.

The illustrated image display device 100 has a structure which is similar to glasses for eyesight correction. Virtual image optical units 101L and 101R which are formed by transparent light guiding units, or the like, are arranged at positions of a main body of the image display device 100, which face left and right eyes of a user, and an image which is observed by the user is displayed in the respective virtual image optical units 101L and 101R. The virtual image optical units 101L and 101R are supported by a glasses frame-shaped support body 102, for example.

An external camera 512 for inputting a surrounding image (field of vision of user) is arranged in a substantially center of the glasses frame-shaped support body 102. It is more preferable to configure the external cameras 512 using a plurality of cameras so as to obtain three-dimensional information of the peripheral image using parallax information. In addition, microphones 103L and 103R are arranged in the vicinity of both ends of the support body 102 on the left and right. Since there are microphones 103L and 103R which are approximately symmetric on the left and right, it is possible to separate out an ambient noise, or a talking voice of another person, and to prevent, for example, a malfunction at a time of operating using a voice input by recognizing only a voice which is oriented in the center (voice of user).

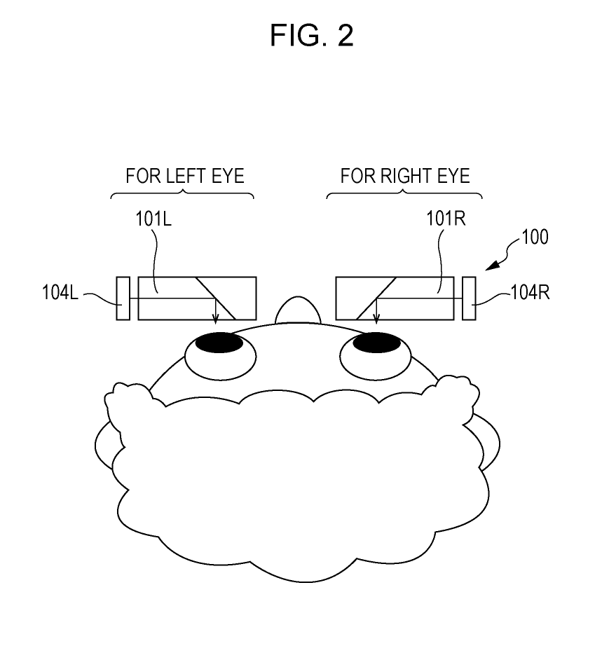

FIG. 2 illustrates a state in which the image display device 100 which is worn by a user is viewed from the top. As illustrated, display panels 104L and 104R which display and output respective left eye image and right eye image are arranged on both left and right ends of the image display device 100. Each of display panels 104L and 104R is formed by a micro display such as a liquid crystal display, an organic EL device, or the like. Left and right display images which are output from the display panels 104L and 104R are guided to the vicinity of the respective left and right eyes by the virtual image optical units 101L and 101R, and enlarged virtual images thereof are formed in pupils of a user.

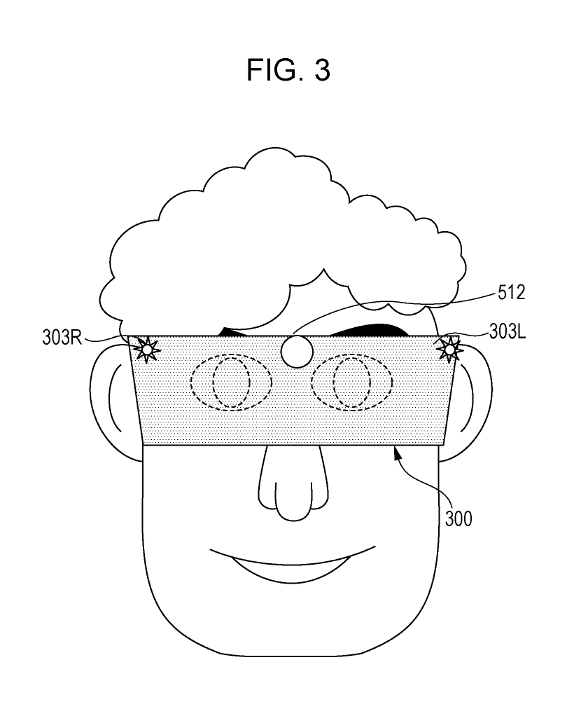

In addition, FIG. 3 illustrates an external configuration of an image display device 300 according to another embodiment of the technology which is disclosed in the specification. The image display device 300 is used by being mounted on the head or a face of a user, however, the device is a light blocking-type, directly covers eyes of a user when being mounted on the head, and can provide a level of concentration to a user who is seeing and hearing an image. In addition, differently from the see-through type, a user who is wearing the image display device 300 is not able to directly view scenery in a real world, however, the user is able to indirectly view the scenery in the real world (that is, seeing through using video), when equipping the external camera 512 which photographs scenery in the gaze direction of the user, and by displaying the imaged image. As a matter of course, it is possible to show a virtual display image by overlapping the image with an image in a video see-through mode. Since the display image is not viewed from the outside (that is, another person), it is possible to easily protect a privacy when displaying information.

The image display device 300 can also be used when displaying a result which is estimated or diagnosed with respect to a target in a field of vision of a user, however, this point will be described in detail later.

The illustrated image display device 300 is a structure which is similar to a hat shape, and is configured so as to directly cover left and right eyes of a user who is wearing the device. Display panels which are observed by a user (not shown in FIG. 3) are arranged at positions in a main body of the image display device 300, which face left and right eyes. The display panel is configured of a micro display such as an organic EL device, or a liquid crystal device, for example.

An external camera 512 for inputting a surrounding image (field of vision of user) is arranged in the approximately center of a front face of a main body of the image display device 300 which has a hat-like shape. In addition, microphones 303L and 303R are respectively arranged in the vicinity of both the left and right ends of the main body of the image display device 300. Since there are microphones 303L and 303R which are approximately symmetric on the left and right, it is possible to separate out an ambient noise, or a talking voice of another person, and to prevent, for example, a malfunction at time of operating using a voice input by recognizing only a voice which is oriented in the center (voice of user).

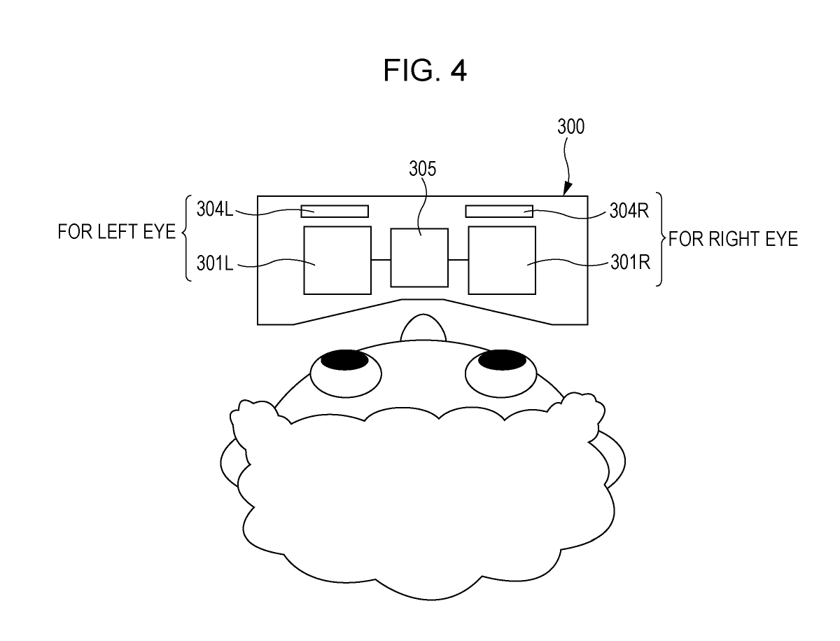

FIG. 4 illustrates a state in which a user who is wearing the image display device 300 illustrated in FIG. 3 is viewed from the top. The illustrated image display device 300 includes display panels 304L and 304R for left and right eyes at side surfaces facing a face of the user. The display panels 304L and 304R are configured of a micro display such as an organic EL device, or a liquid crystal device, for example. Display images of the display panels 304L and 304R are observed by the user as enlarged virtual images by passing through the virtual image optical units 301L and 301R. In addition, since there are individual differences in the height or the width of eyes in each user, it is necessary to align positions of each display system on the left and right and eyes of the user who is wearing the device. In the example which is illustrated in FIG. 4, an eye width adjusting mechanism 305 is provided between the right eye display panel and the left eye display panel.

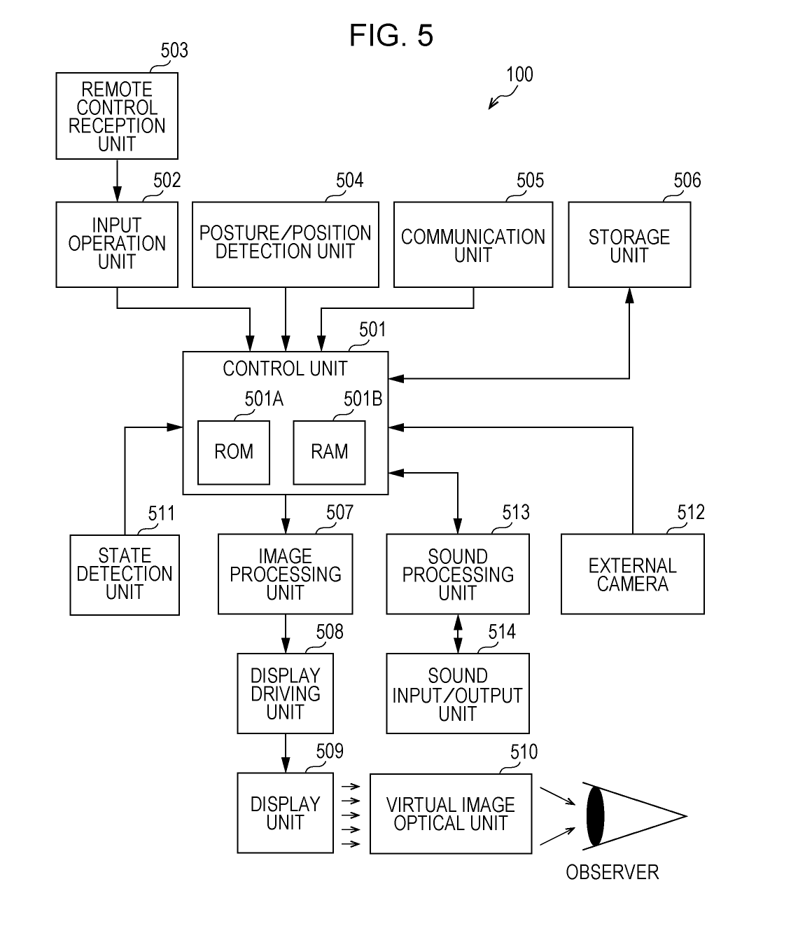

FIG. 5 illustrates an internal configuration example of the image display device 100. An internal configuration of the other image display device 300 is the same as that of the image display device 100. Hereinafter, each unit will be described.

A control unit 501 includes a Read Only Memory (ROM) 501A, or a Random Access Memory (RAM) 501B. A program code which will be executed in the control unit 501, or various data items are stored in the ROM 501A. The control unit 501 integrally controls the whole operation of the image display device 100 including a display control of an image by executing a program which is downloaded in the RAM 501B. There are an image display control program, an image processing program of an image which is photographed using the external camera 512 (for example, image in which gaze direction of user is photographed), a communication processing program for an external device such as a server on the Internet (not shown), and identification information which is unique to the device 100 as programs or data items which are stored in the ROM 501A. The image processing program of the image which is photographed using the external camera 512 performs, for example, an analysis of the photographed image, and a display control of an analysis result. The analysis of the photographed image includes an estimating process or a diagnosis process with respect to a target in a field of vision of a user such as a diagnosis, or fortune-telling based on physical features such as palm reading when photographing a palm, face reading when photographing a face, a fair skin diagnosis based on a face image, Chinese geomancy in indoor photographing, and layout diagnoses other than these. In addition, the image processing program displays and controls the analysis result by overlapping the result with the field of vision of the user (including seeing-through, and video see-through). The image processing will be described in detail later.

An input operation unit 502 includes one or more operators such as a key, buttons, or a switch with which a user performs an input operation, receives instructions from a user through the operator, and outputs the instructions to the control unit 501. In addition, the input operation unit 502 similarly receives instructions from the user which are formed by a remote controlled command which is received in a remote control reception unit 503, and outputs the instructions to the control unit 501.

A posture/position detection unit 504 is a unit which detects a posture of the head of a user who is wearing the image display device 100. The posture/position detection unit 504 is configured of any one of a gyro sensor, an acceleration sensor, a Global Positioning System (GPS) sensor, and a magnetic field sensor, or a combination of two or more sensors in consideration of good points and bad points of each sensor.

A state detection unit 511 obtains state information on a state of a user who is wearing the image display device 100, and outputs the information to the control unit 501. The unit obtains, for example, a work state of the user (whether or not wearing image display device 100), an action state of the user (moving state such as stopped, walking, running, open and shut state of eyelids, gaze direction), a mental state (excitement degree, awakening degree, feelings, emotions, or the like, for example, whether or not user is devoted to, or concentrating on display image while viewing), and a physical state as state information. In addition, the state detection unit 511 may include various state sensors (none of those is illustrated in figures) such as a wearing sensor which is formed by a machine switch, or the like, an internal camera which photographs a face of a user, a gyro sensor, an acceleration sensor, a speed sensor, a pressure sensor, a body temperature sensor, a sweat sensor, a myoelectricity sensor, an ocular potential sensor, and an electroencephalographic sensor, in order to obtain these pieces of state information from the user.

The external camera 512 is arranged in the approximately center of a front face of the main body of the image display device 100 which has a glasses shape, for example (refer to FIG. 1), and can photograph a surrounding image. In addition, by performing panning, tilting, and posture control in the rolling direction of the external camera 512 according to the gaze direction of the user which is detected in the state detection unit 511, it is possible to photograph an image of a glance of the user himself, that is, an image in the gaze direction of the user using the external camera 512. It is possible to display and output the photographed image of the external camera 512 to a display unit 509, and it is also possible to store the image in a storage unit 506.

A communication unit 505 performs communication processing with an external device such as a server on the Internet (not shown), and processing of modulation and demodulation, and encoding and decoding of a communication signal. In addition, the control unit 501 sends out transmission data to the external device from the communication unit 505. A configuration of the communication unit 505 is arbitrary. For example, the communication unit 505 can be configured according to a communication standard which is used in a transceiving operation with the external device as a communication partner. The communication standard may be either a wired one or a wireless one. As the communication standard, there are a Mobile High-definition Link (MHL), a Universal Serial Bus (UBS), a High Definition Multimedia Interface (HDMI), Wi-Fi (registered trade mark), a Bluetooth (registered trade mark) communication, an infrared communication, and the like.

The storage unit 506 is a mass storage device which is formed by a Solid State Drive (SSD), or the like. The storage unit 506 stores an application program which is executed in the control unit 501, or data such as an image which is photographed using the external camera 512 (which will be described later), or an image which is obtained from a network through the communication unit 505. In addition, the storage unit 506 may accumulate a diagnosis database (which will be described later) relating to a diagnosis, or fortune-telling based on physical characteristics such as palm lines or physiognomy, a skin diagnosis, a position of the foot acupuncture point for performing an estimating process, or a diagnosis process with respect to an image which is photographed in the external camera 512. In addition, the diagnosis result which is obtained by performing the estimating process, or the diagnosis process with respect to the image (including image with which diagnosis result is overlapped) may be accumulated in the storage unit 506 for reuse, or for purposes other than that.

An image processing unit 507 further performs signal processing such as an image quality correction with respect to an image signal which is output from the control unit 501, and converts the image signal into a resolution corresponding to a screen of the display unit 509. In addition, a display driving unit 508 sequentially selects pixels of the display unit 509 in each row, performs line sequential scanning of the pixels, and supplies pixel signals based on the image signal which is subject to the signal processing.

The display unit 509 includes a display panel which is configured of a micro display such as an organic electro-luminescence (EL) device, or a liquid crystal display, for example. A virtual image optical unit 510 projects a display image of the display unit 509 by enlarging the image, and causes a user to observe the image as an enlarged virtual image.

A sound processing unit 513 performs a sound quality correction, or sound amplification with respect to a sound signal which is output from the control unit 501, and further performs signal processing of an input sound signal, or the like. In addition, a sound input/output unit 514 performs outputting of sound which is subject to sound processing to the outside, and performs inputting of sound from the microphone (which was described above).

B. Presentation of Information Using Image Display Device

The image display device 100 which is used by being mounted on the head or a face of a user can present information to a user in a form in which a virtual display image is overlapped with scenery in a real world which the user really views. For example, the user can exactly understand what the information is, when a virtual image which denotes information relating to an object which exists in a field of vision of the user is displayed by being overlapped with the object.

In addition, even in a case of the immersive-type image display device 300 (not see-through type), it is possible to execute the same information presentation as that in the above descriptions by photographing scenery in a real world which exists in a field of vision of a user using the external camera 512, and displaying a virtual image by overlapping the image with an image in a video see-through mode thereof.

On the other hand, a method in which an estimating process, or a diagnosis process based on visual biological information which is extracted from a specified portion on a body of a user, including a diagnosis or fortune telling based on physical characteristics such as palm lines or physiognomy are performed using an image analysis has been used before.

Accordingly, in the image display device 100 (and 300) according to the embodiment, when the image in the gaze direction of the user is photographed using the external camera 512, it is possible to present to a user a result of an estimation or a diagnosis of a target in a field of vision of himself so as to be easily understood, when performing a see-through display (including video see-through display) of the result of the estimation or the diagnosis which is obtained by performing an image analysis of a target (specified portion on body of a person, such as palm or face of user, for example) which is included in a photographed image by overlapping the result with scenery in a real world which the user views.

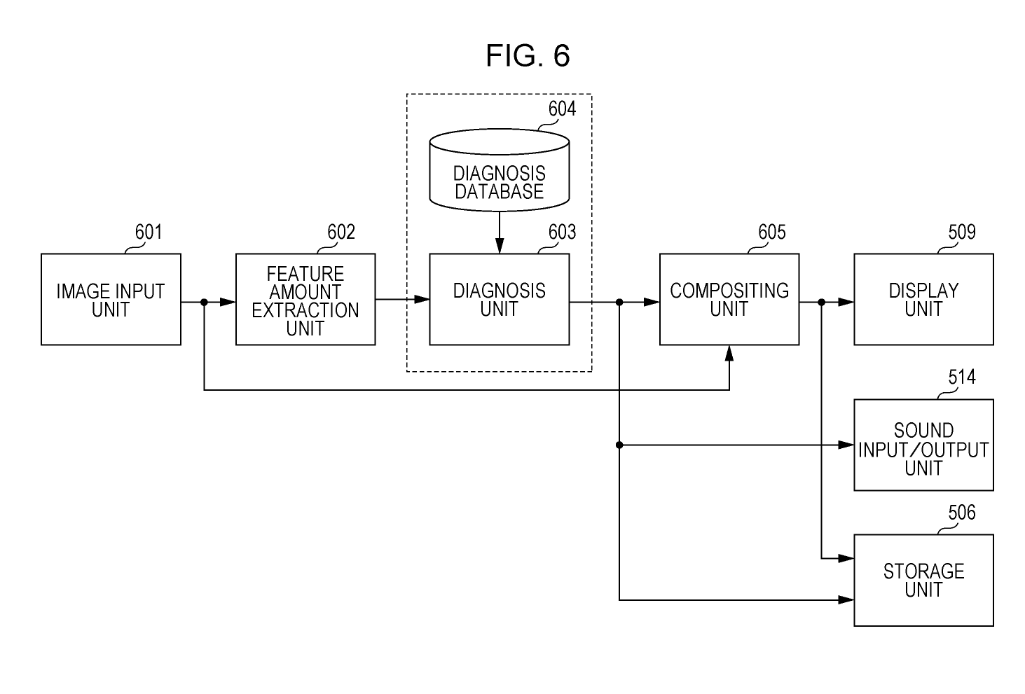

FIG. 6 schematically illustrates a functional configuration of the image display device 100 in which a result of an estimation or a diagnosis with respect to a target in a field of vision of a user is displayed by being overlapped with the field of vision of the user. The illustrated functional configuration can be realized when the control unit 501 executes a predetermined program, for example.

An image input unit 601 inputs, for example, a photographed image of the external camera 512, a past photographed image which is stored in the storage unit 506, and an image which is taken in from the outside through the communication unit 505 (for example, image in gaze direction of another user, or image which is shown on network).

As described above, the external camera 512 photographs an image in the gaze direction of a user by performing a posture control according to the gaze direction of the user which is detected using the state detection unit 511. In this case, a live image in the gaze direction of the user is input to an image input unit 601. As a matter of course, it is also possible to input the past photographed image in the gaze direction of the user which is stored in the storage unit 506 to the image input unit 601.

The feature amount extraction unit 602 extracts a feature amount which is used in diagnosis processing in the subsequent stage from the image which is input to the image input unit 601. In addition, a diagnosis unit 603 collates the feature amount which is extracted in the feature amount extraction unit 602 with a feature amount for a diagnosis in a diagnosis database 604, performs diagnosis processing, and generates a diagnosis result thereof. The diagnosis unit 603 outputs the diagnosis result to a compositing unit 605 for the subsequent stage. In addition, the diagnosis unit 603 may store the diagnosis result in the storage unit 506 for a purpose of reusing, or the like.

In addition, the diagnosis unit 603 and the diagnosis database 604 (portion surrounded with dotted line in FIG. 6) are not necessarily built into the image display device 100. It is also possible to build the diagnosis unit 603 and the diagnosis database 604 using an external computing resource such as a server on a network which is connected through the communication unit 505, for example. In this case, the feature amount which is extracted from the input image in the feature amount extraction unit 602 is transmitted to the server in the communication unit 505, and a diagnosis result is received in the communication unit 505. In addition, the feature amount extraction unit 602 may also be arranged at the outside, not in the image display device 100, and in this case, the input image is transmitted from the communication unit 505 as is.

The compositing unit 605 composites a virtual image in which the diagnosis result which is generated in the diagnosis unit 603 is overlapped with the input image of the image input unit 601. In addition, the compositing unit displays and outputs the virtual image to the display unit 509, and displays the diagnosis result in a see-through mode (including video see-through display) by overlapping the result with the input image (scenery in real world which user views). In addition, when the diagnosis result of the diagnosis unit 603 with respect to the input image is output as sound information, as well, the result is output to the outside from the sound input/output unit 514. In addition, the image which is composited in the compositing unit 605 may be stored in the storage unit 506 for a purpose of reusing, or the like.

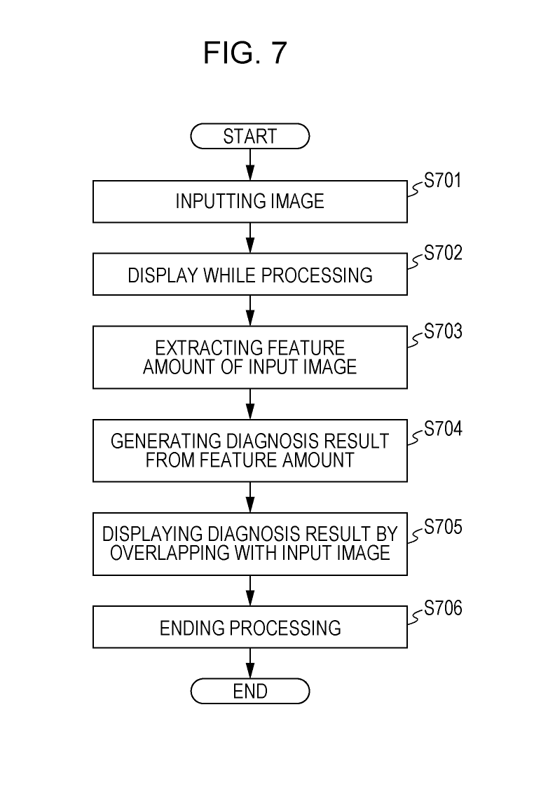

In addition, FIG. 7 illustrates a processing order for displaying a result of an estimation or a diagnosis with respect to a target in a field of vision of a user by overlapping the result with the field of vision of the user in the image display device 100 in a form of a flowchart. The illustrated processing order is executed when the control unit 501 executes a predetermined program, for example.

The processing is started along with power up of the image display device 100, for example, or is started in response to an instruction of starting of the processing which is instructed by a user through the input operation unit 502, or the like.

In addition, the image input unit 601 inputs a live image which is photographed using the external camera 512 during the startup of the processing (step S701). The external camera 512 photographs an image in the gaze direction of a user, for example. However, the image input unit 601 may input the past photographed image which is stored in the storage unit 506, or the image which is taken in from the outside through the communication unit 505. The input image in the processing is displayed, and output to the display unit 509 (step S702).

In addition, the feature amount extraction unit 602 extracts a feature amount which will be used in the diagnosis processing in the subsequent stage from the image which is input to the image input unit 601 (step S703).

Subsequently, the diagnosis unit 603 performs diagnosis processing by collating the feature amount which is extracted from the feature amount extraction unit 602 with the feature amount for diagnosing in the diagnosis database 604, and generates a diagnosis result thereof (step S704). The obtained diagnosis result may be stored in the storage unit 506.

Subsequently, the compositing unit 605 composites a virtual image in which the diagnosis result which is generated in the diagnosis unit 603 is overlapped with the input image of the image input unit 601. In addition, the compositing unit displays, and outputs the virtual image to the display unit 509, and displays the diagnosis result in a see-through mode (including video see-through display) by overlapping the result with the input image (scenery in real world which user views) (step S705). In addition, when the diagnosis unit 603 outputs the diagnosis result with respect to the input image as sound information, as well, the result is output to the outside from the sound input/output unit 514. The image in which the diagnosis result is composited, or the sound information may be stored in the storage unit 506 for a purpose of reusing, or the like.

Thereafter, ending processing is executed in response to an instruction of ending the processing from the user which is performed through the input operation unit 502, or the like (step S706), and the process routine is ended.

In the ending processing, the diagnosis result which is obtained in step S704, storing in the storage unit 506 or uploading to the server of the information such as the virtual image which is composited by the compositing unit 605 in step S705, updating processing of the diagnosis database 604, or the like, may be included.

In the diagnosis processing which is performed in the diagnosis unit 603, there is estimating processing, or a diagnosis processing with respect to a target in a field of vision of a user, such as a diagnosis or fortune-telling based on physical characteristics, for example, palm reading when the user who is wearing the image display device 100 views a palm of his own, or another person, face reading when the user views a face of another person (or his own face reflected on mirror), a diagnosis of physiognomy of a house when observing a house or a building, a fair skin diagnosis when viewing a face of another person (or his own face reflected on mirror), fortune-telling in Chinese geomancy when viewing a room, and layout diagnoses other than these. According to the embodiment, the diagnosis unit 603 performs the above described diagnosis with respect to the input image of the image input unit 601, such as the image which is photographed by the external camera 512 in the gaze direction of the user. In addition, the compositing unit 605 composites the diagnosis result so as to be overlapped with the input image, and displays and outputs the result onto the display unit 509. Accordingly, the user is able to understand the diagnosis contents more specifically and accurately, for example, on which specific portion in the input image, the diagnosis result is grounded, or the like, without merely accepting the diagnosis result.

B-1. Palm Reading

First, a case of performing palm reading will be described as an example of a diagnosis or fortune-telling based on physical characteristics.

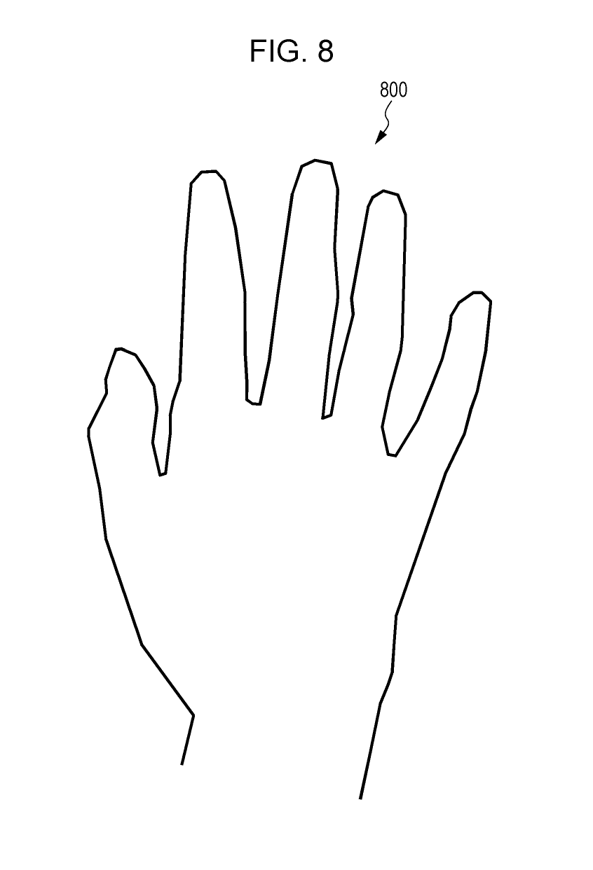

FIG. 8 exemplifies an image 800 of a left palm of a user himself which is in a field of vision of the user who is wearing the image display device 100. The image input unit 601 can input the palm image 800 which is in the field of vision of the user using the external camera 512. In addition, the palm image 800 does not necessarily have to be a real time image which is photographed using the external camera 512, and may be the past photographed image which is temporarily stored in the storage unit 506, or may be a palm image of his own or another person which is downloaded through the communication unit 505.

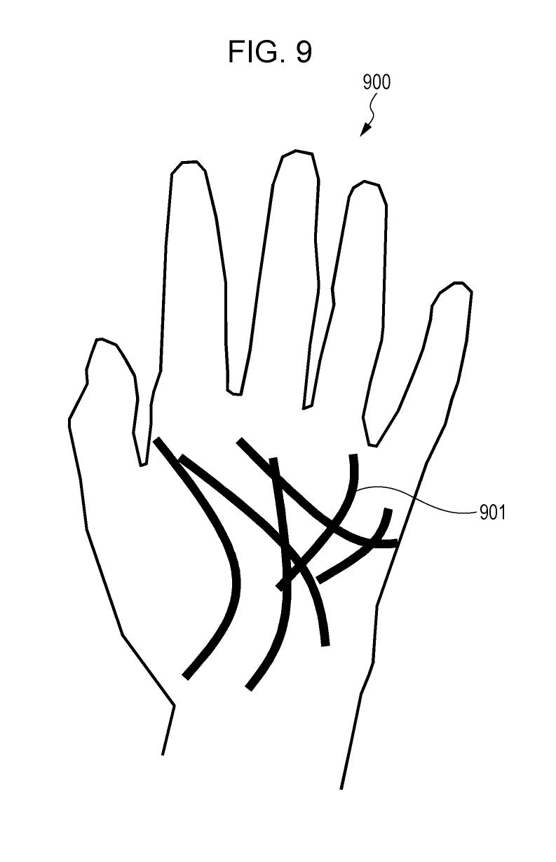

The feature amount extraction unit 602 extracts palm lines from the input palm image as a feature amount of the palm, and outputs information of each palm line to the diagnosis unit 603. In addition, the compositing unit 605 displays and outputs each palm line 901 which is extracted from the palm onto the display unit 509 by overlapping the palm line with a palm image 900, as a display image in the middle of the processing, that is, as a display image in the middle of palm reading (refer to FIG. 9).

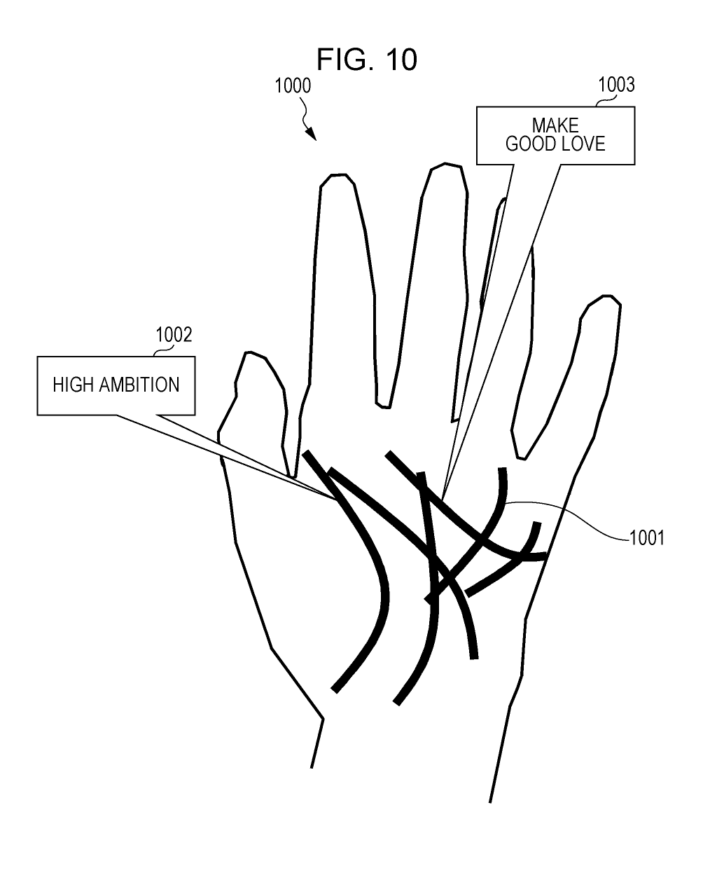

In addition, the diagnosis unit 603 collates each palm line which is extracted in the feature amount extraction unit 602 with the palm line database in the diagnosis database 604, performs palm reading, and generates a diagnosis result thereof. In addition, the compositing unit 605 composites a virtual image in which the diagnosis result which is generated in the diagnosis unit 603 is overlapped with the input image of the image input unit 601, and as illustrated in FIG. 10, the compositing unit displays and outputs the result onto the display unit 509 by overlapping the result with the original palm image 1000. In the illustrated example, meanings of each palm line 1001 are displayed in forms of balloons 1002 and 1003 which appear from the palm lines. Accordingly, since the user is able to visually confirm on which palm line the diagnosis result is grounded by comparing to the case in which palm reading data such as fortune in marriage, fortune in love, fortune in work, fortune in money is displayed in a text format (for example, refer to Japanese Unexamined Patent Application Publication No. 2007-183, and Japanese Unexamined Patent Application Publication No. 2010-123020), the user can easily understand the diagnosis result, and the diagnosis result becomes more reliable.

In addition, there is an opinion that palm lines on each of the left and right hands have different meanings (for example, there is opinion that palm lines on a person's dominant hand tells acquired talent or future of the person, and palm lines on the other hand tells inborn talent or past of the person). For this reason, it is necessary to perform palm reading on both hands, preferably, when performing the palm reading. However, in a case of a system which is subject to a condition that a user photographs his own palm using a mobile terminal with a camera, or a digital camera (for example, refer to Japanese Unexamined Patent Application Publication No. 2007-183, and Japanese Unexamined Patent Application Publication No. 2010-123020), the user should perform photographing of the respective left and right hands while having a camera, and this takes twice the labor.

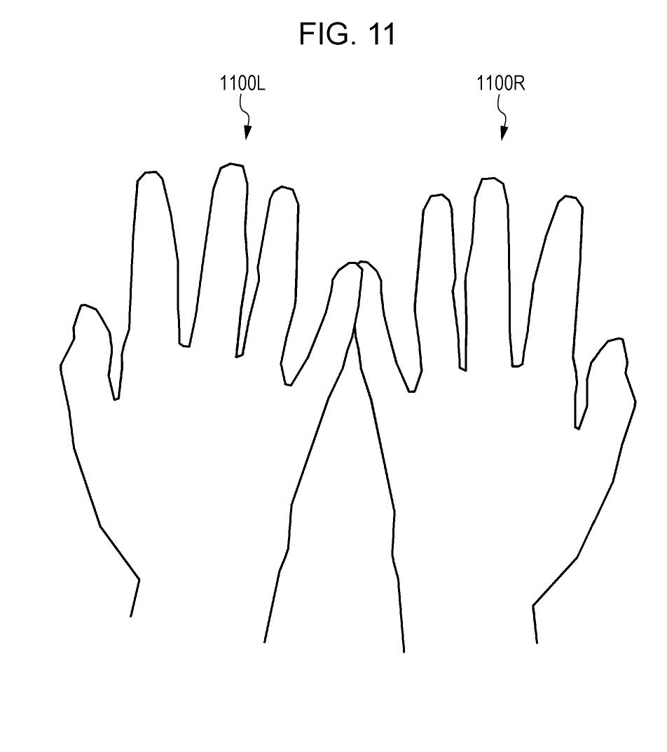

In contrast to this, according to the embodiment, an image input is performed using the external camera 512 of the image display device 100 which is mounted on the head or a face of a user. That is, it is possible to input the left and right palm images 1100 of the user at the same time, as illustrated in FIG. 11, since the user performs the image input with both hands which are free, and accordingly, it is possible to save time.

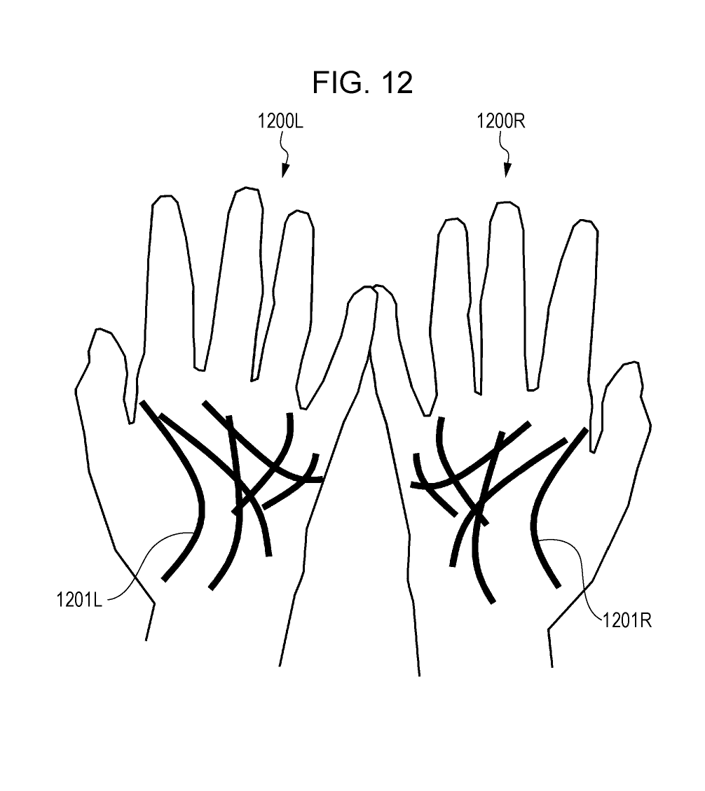

In addition, the feature amount extraction unit 602 extracts palm lines 1201L and 1201R at the same time from each of the left and right palms, and displays and outputs the palm lines onto the display unit 509 by overlapping the palm lines with respective palm images 1200L and 1200R (refer to FIG. 12).

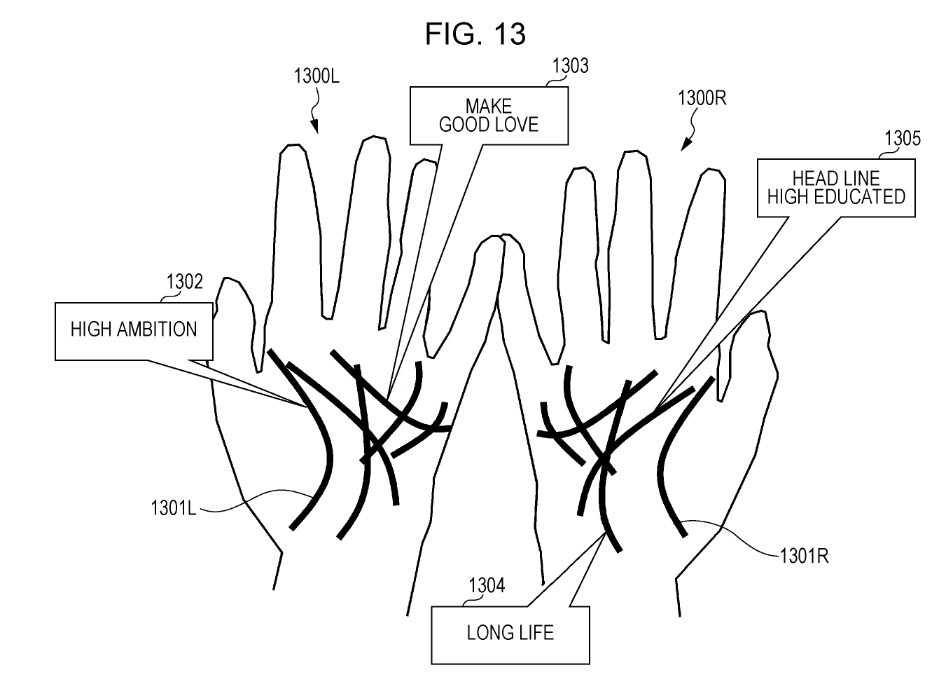

In addition, the diagnosis unit 603 performs palm reading by collating each of the left and right palm lines 1301L and 1301R which are extracted in the feature amount extraction unit 602 with the palm line database in the diagnosis database 604, and displays meanings of each of the palm lines 1301L and 1301R in forms of balloons 1302 to 1305 which appear from the palm lines (refer to FIG. 13).

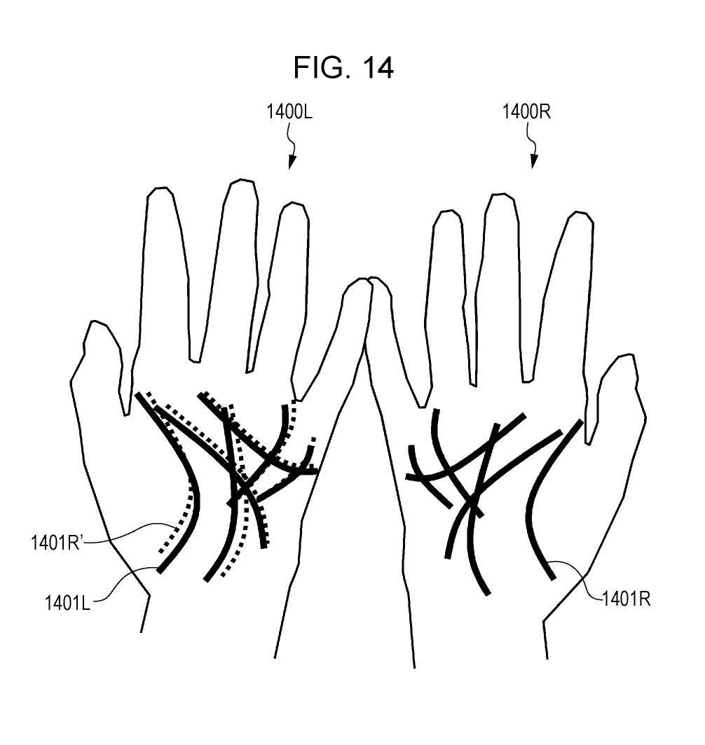

As illustrated in FIG. 14, the compositing unit 605 generates an image 1401R′ (denoted by dotted line in figure) in which palm lines 1401R on the right hand between the respective left and right palm lines 1401L and 1401R which are extracted from the left and right palms 1400L and 1400R of the user by the feature amount extraction unit 602 are inverted from left to right, and the image may be displayed by being overlapped with the palm lines 1401L on the left hand image 1400L. The user can understand that his left and right palm lines are different from each other at a glance through the image which is illustrated in FIG. 14, and to confirm resembling palm lines on the left and right, and palm lines which are remarkably different on the left and right. In addition, it is possible to presume whether the diagnosed fortune in marriage, fortune in love, fortune in work, fortune in money, or the like, is grounded on innateness, or a postnatal nature.

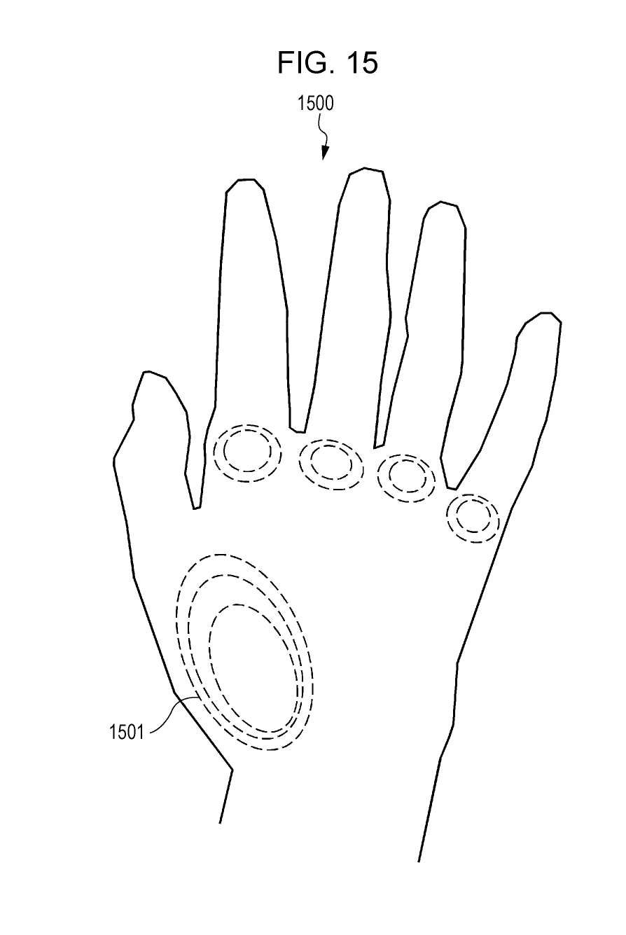

In addition, a method has been used in which a talent or a character is read based on uprising portions of the bases of the respective five fingers, that is, the “palm hill”. Accordingly, the feature amount extraction unit 602 may extract information relating to the irregularity on the palm from a palm image which is input from the image input unit 601, as a feature amount. For example, when the external camera 512 is configured of a plurality of cameras, it is possible to obtain three-dimensional information of a palm based on parallax information which is obtained from a photographed image of each camera. In addition, as illustrated in FIG. 15, the compositing unit 605 may display contour 1501 which denotes a response of the palm (denoted by dotted line in the figure) by overlapping the contour with the input palm image 1500.

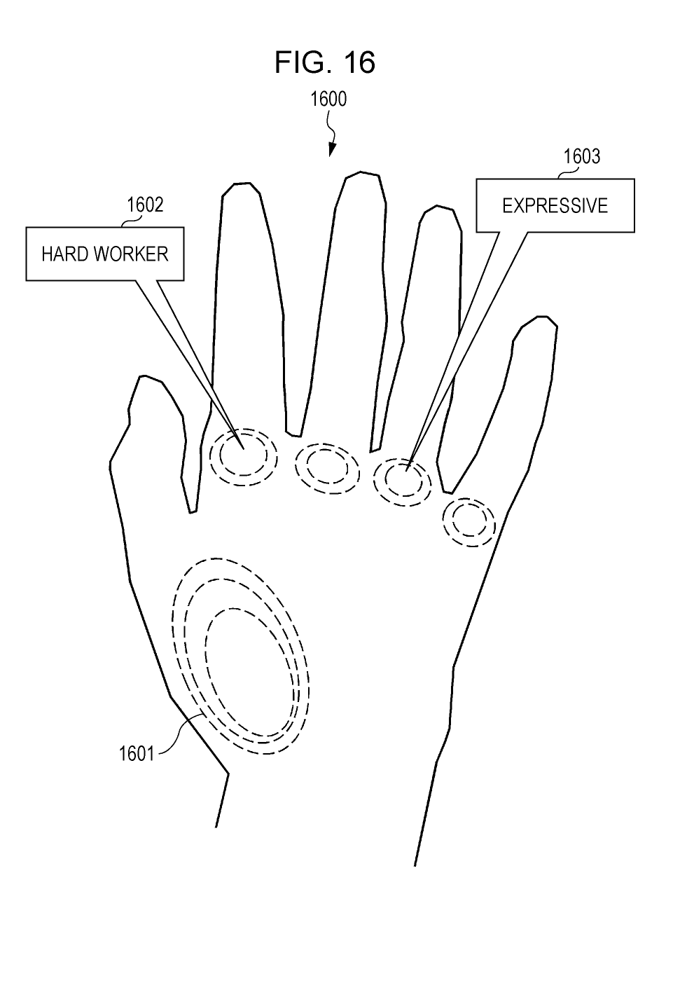

In addition, the diagnosis unit 603 collates the palm hill of the base of each finger which is extracted in the feature amount extraction unit 602 with a palm hill database in the diagnosis database 604, and generates a diagnosis result thereof. In addition, the compositing unit 605 composites a virtual image in which the diagnosis result which is generated in the diagnosis unit 603 is overlapped with the input image of the image input unit 601, overlaps the virtual image with the original palm image 1600, as illustrated in FIG. 16, and displays and outputs the image onto the display unit 509. In the illustrated example, a meaning of the palm hill 1601 of the base of each finger is displayed in forms of balloons 1602 and 1603 which appear from the palm hill. Since the user is able to visually confirm on which palm hill a diagnosis result of a talent or a character is grounded, it is possible for the user to easily understand the diagnosis result, and the diagnosis result becomes more reliable.

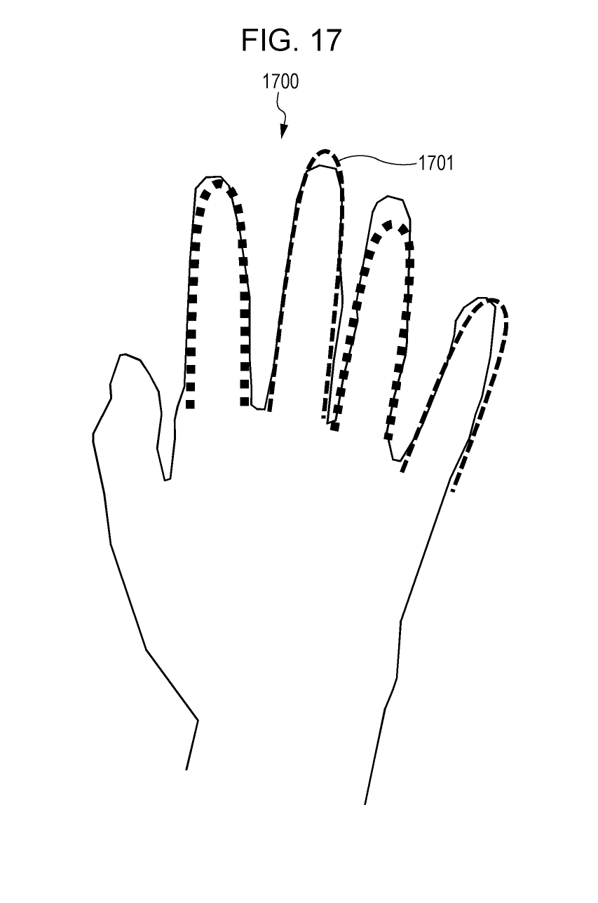

In addition, it is by no means chirognomy, however, a method has also been used in which a talent or a character of a person is diagnosed based on the length of fingers as visual information of a palm. In this case, the feature amount extraction unit 602 calculates information on the length of a finger with respect to all of five fingers, or a part of fingers which is focused on from a palm image which is input from the image input unit 601, as a feature amount. As illustrated in FIG. 17, the compositing unit 605 may display a virtual finger image 1701 (denoted by dotted line in the figure) with the standard length by overlapping the image with an input palm image 1700. When performing a diagnosis, a virtual finger which will be focused on in particular may be displayed using a thick dotted line (in the figure, two virtual fingers of forefinger and ring finger which are focused on in particular are denoted using thick dotted line).

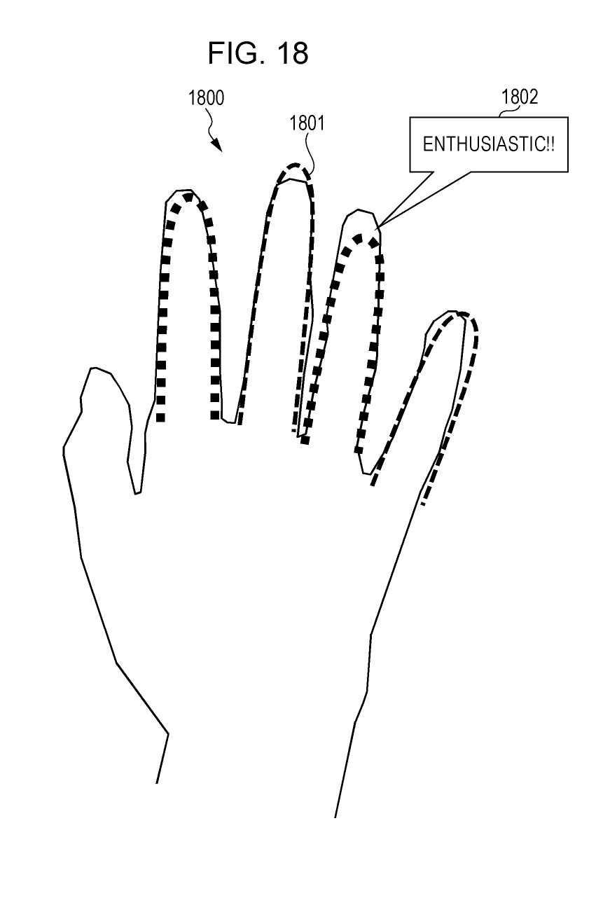

In addition, the diagnosis unit 603 collates the length of each finger which is extracted in the feature amount extraction unit 602 with the finger length database in the diagnosis database 604, performs a diagnosis of a talent or a character of the person, and generates a diagnosis result thereof. In addition, the compositing unit 605 composites a virtual image in which the diagnosis result which is generated by the diagnosis unit 603 is overlapped with an input image of the image input unit 601, and displays and outputs the virtual image onto the display unit 509 by overlapping the image with the original palm image 1800, as illustrated in FIG. 18. In the illustrated example, a result which is diagnosed based on the length of the ring finger is displayed in a form of a balloon 1802 which appears from the tip end of the ring finger. In addition, a virtual finger image 1801 with the standard length is displayed by being overlapped with the actual palm image 1800, and a virtual finger of a finger which is focused on in particular when diagnosing is displayed using a thick dotted line (the same as above). Since a user is able to visually confirm on which finger the diagnosis result of a talent or a character is grounded, it is possible for the user to easily understand the diagnosis result, and the diagnosis result becomes more reliable.

B-2. Face Reading

Subsequently, a case of performing face reading will be described as another example of a diagnosis or fortune telling based on physical characteristics.

The image input unit 601 inputs a face image of a user which is photographed using the internal camera (which is described above) which is included in the state detection unit 511, or a face image of a person who is in front of the user's eyes which is photographed using the external camera 512. Alternatively, a face image which is photographed in the past using the internal camera or the external camera 512 may be taken from the storage unit 506, or a face image which is downloaded from an external server through the communication unit 505 may be input.

The feature amount extraction unit 602 extracts a face feature amount such as an outline, a size, a hue, or the like, of a portion which is a diagnosis target from the input face image, and outputs the face feature amount to the diagnosis unit 603. In addition, the diagnosis unit 603 performs face reading by collating the face feature amount which is extracted in the feature amount extraction unit 602 with a physiognomy database in the diagnosis database 604.

When performing the face reading, a shape of the whole face, and a shape or a size of parts of the face such as eyes, a nose, ears, a mouth, eyebrows, a chin, and the like, are referred to in general.

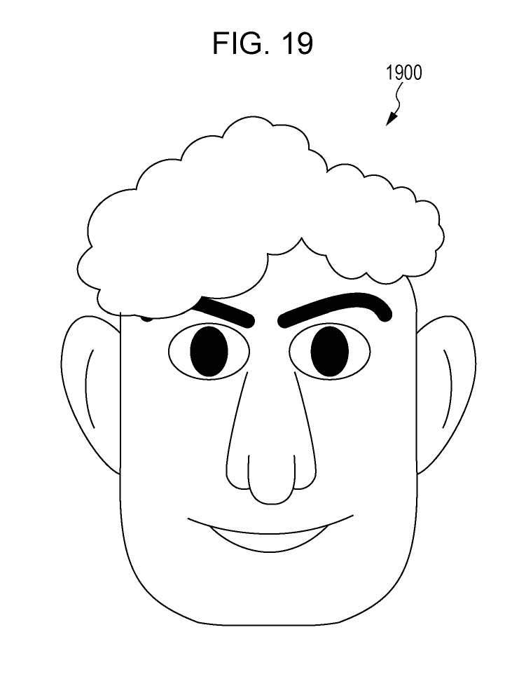

For example, in the face reading using a nose, a size of the whole nose, the height of the nose, color of the nose, a shape of a tip of the nose, nostrils and a vertical groove thereof, and the like, are used. FIG. 19 exemplifies a face image including a nose which is input using the internal camera, or the external camera 512 by the image input unit 601.

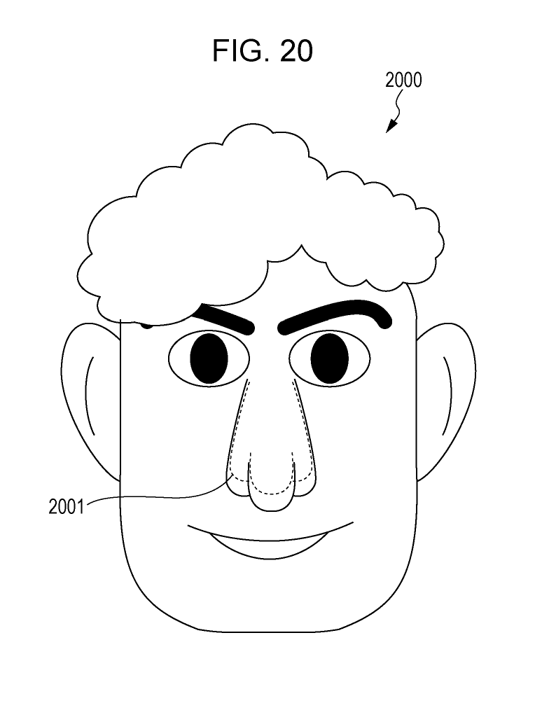

The feature amount extraction unit 602 extracts a feature amount of a face such as a size of the whole nose, the height of the nose, the color of the nose, the shape of a tip of the nose, the nostrils and the vertical groove thereof, and the like, from the face image which is input in the image input unit 601. The compositing unit 605 displays an image 2001 (denoted by dotted line in the figure) of a virtual nose which has a size, height, a shape, and the like, which are standard by overlapping the image with an input face image 2000, as illustrated in FIG. 20.

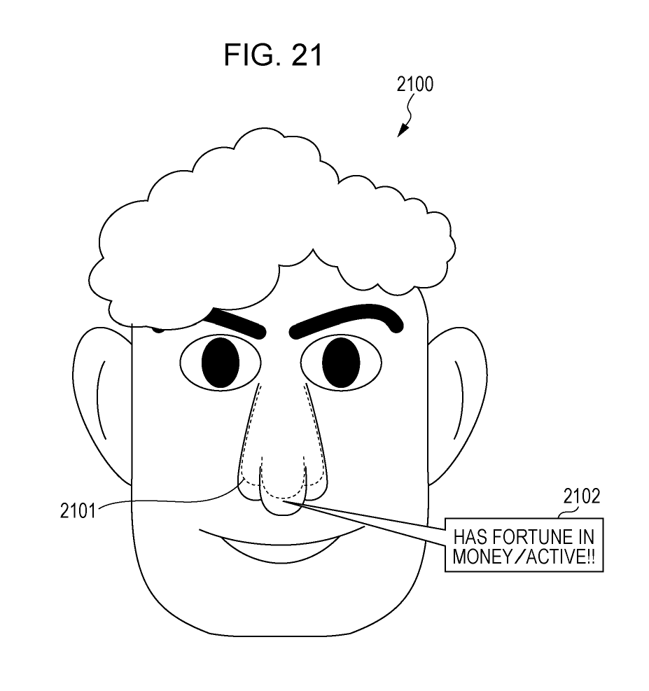

In addition, the diagnosis unit 603 collates each feature amount of the face such as a size of the whole nose, the height of the nose, the color of the nose, the shape of the tip of the nose, the nostrils and the vertical groove thereof, and the like, with the physiognomy database in the diagnosis database 604, and diagnoses fortune such as fortune in money or family fortune, or a character such as an acting power. In addition, the compositing unit 605 composites a virtual image in which a diagnosis result which is generated in the diagnosis unit 603 is overlapped with an input image of the image input unit 601, and displays and outputs the result onto the display unit 509 by overlapping the result with the face image 2100, as illustrated in FIG. 21. In the illustrated example, a result of the face reading using the size of the whole nose, the height of the nose, the color of the nose, the shape of the tip of the nose, the nostrils and the vertical groove thereof, and the like, is displayed in a form of a balloon 2102 which appears from the nose. Since the user can visually confirm on which face part the diagnosis result of fortune or a character of an owner of the face image is grounded, it is possible for the user to easily understand the diagnosis result, and the diagnosis result becomes more reliable.

B-3. Fair Skin Diagnosis

In addition, it is possible to perform a skin diagnosis, in addition to the physiognomy. For example, a technology in which a texture analysis, a blemish analysis e, an analysis of skin color, a sebum analysis, or the like, is performed using a measurement of a partial image of a face, or a technology in which a wrinkle/pore analysis, the blemish analysis, a porphyrin analysis, or the like, is performed using a measurement of an image of the whole face (for example, refer to Japanese Unexamined Patent Application Publication No. 2007-130104), or a highly precise skin analysis such as moisture retention using a near infrared camera is performed (for example, refer to Japanese Unexamined Patent Application Publication No. 2011-206513) has been known.

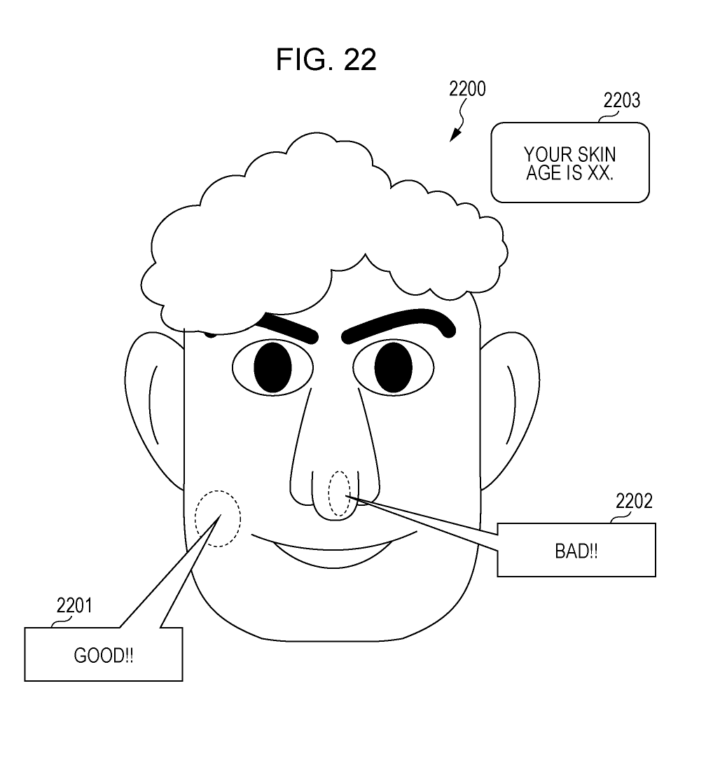

Accordingly, the feature amount extraction unit 602 performs the texture analysis, the blemish analysis, the analysis of skin color, the sebum analysis, or the like, using the measurement of the partial image with respect to the user's own face which is photographed using the internal camera, or a face of another person which is photographed using the external camera 512, or performs the wrinkle/pore analysis, the blemish analysis, the porphyrin analysis, or the like, using the measurement of the image of the whole face, and outputs an analysis result to the diagnosis unit 603. Alternatively, the feature amount extraction unit 602 performs a skin analysis using a near infrared area of a face image which is photographed using the internal camera or the external camera 512, and outputs an analysis result to the diagnosis unit 603. The diagnosis unit 603 can specify a portion of fair skin in a face among other things, or, on the contrary, a portion at which the skin is seriously damaged by collating the face feature amount which is extracted in the feature amount extraction unit 602 with a fair skin database in the diagnosis database 604, and by performing a fair skin diagnosis. In addition, the compositing unit 605 composites a virtual image in which a diagnosis result which is generated in the diagnosis unit 603 is overlapped with an input image of the image input unit 601, and displays and outputs the result onto the display unit 509 by overlapping the result with a face image 2200, as illustrated in FIG. 22. In the illustrated example, the skin diagnosis result is displayed in a form such as a balloon “good” 2201 which appears from a portion of fair skin which is sufficiently cared for in the face image 2200, or, on the contrary, in a form such as a balloon “bad” 2202 which appears from a portion which is seriously damaged. A skin age 2203 which is calculated as an analysis result of the entire face images 2200 may be displayed. The user can easily check with naked eyes which part in the face image should be cared. In addition, the diagnosis result becomes more reliable, thereby making it possible to give the user a desire for skin care.

B-4. Display of Acupuncture Point

Since there are a plurality of face parts such as eyes, eyebrows, a nose, a mouth, and the like, on a face, it is relatively easy to specify a location in the face by targeting a face part. In contrast to this, there is no target on the sole surface, or the like, since approximately uniform skin is spread thereon, and accordingly, it is difficult to specify a location on the sole of the foot.

For example, acupuncture points in the whole body, such as the digestive system or the bronchial system, the brain, and joints are gathered on the sole of the foot, and it is possible to promote recovery by performing massage, or a finger-pressure treatment with respect to an acupuncture point corresponding to a portion of which the function is degraded.

However, since there are so many acupuncture points on the sole of the foot, it is difficult for a general user to remember acupuncture points, and a correlation between each acupuncture point and an effective portion, though it is different in a case of an expert. In addition, though there is a foot acupuncture point table, it is difficult to exactly show the acupuncture point in the foot acupuncture point table on the real sole of the foot, since there are individual differences in a shape or an aspect ratio of the sole of the foot. As a matter of course, it is also difficult to remember an acupuncture point in each location such as the back, not only the sole of the foot.

Therefore, according to the embodiment, when an image in the gaze direction of a user who is viewing the sole of the foot is taken in from the image input unit 601 through the external camera 512, and when the diagnosis unit 603 obtains an acupuncture point corresponding to a portion for which is desired to improve a function, the diagnosis unit displays and outputs a diagnosis result thereof onto the display unit 509 so as to be overlapped with an input image. Accordingly, the user is able to accurately understand the acupuncture point, and to accurately perform massage or a finger-pressure treatment, even when the user does not remember, or refer to the acupuncture point table.

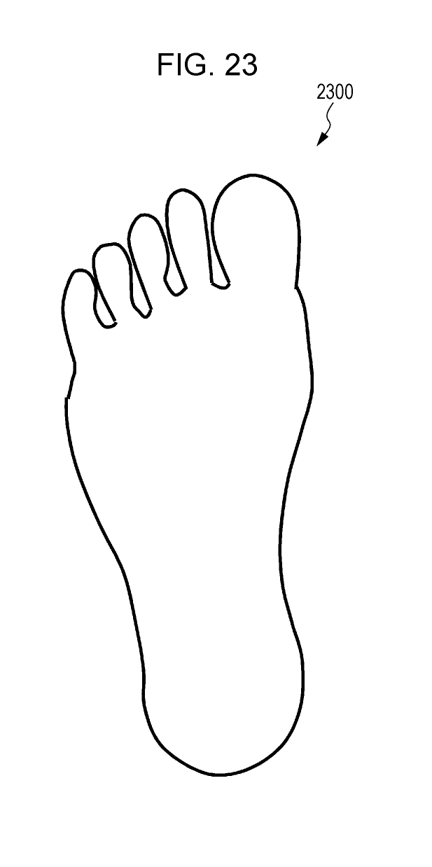

FIG. 23 exemplifies an image 2300 of the sole of the foot of a user himself who is wearing the image display device 100 (or, sole of foot of another person who will be served with foot acupuncture point massage by user) which is in a field of vision of the user. The image input unit 601 can input the image 2300 of the sole of the foot which is in a field of vision of the user using the external camera 512.

Here, the user inputs an instruction denoting a foot acupuncture point corresponding to that portion (for example, stomach) the user is looking for through a sound input, or an operation with respect to the input/output operation unit 502, for example.

The feature amount extraction unit 602 extracts an outline of the sole of the foot 2301 from the input image 2300 as a feature amount, and outputs the outline to the diagnosis unit 603. There are individual differences in a size or a shape, and an aspect ratio of the sole of the foot 2301 which is extracted in feature amount extraction unit.

On the other hand, a table of the sole of the foot (not shown) which denotes each position of the foot acupuncture point on the sole of the foot which has a normalized shape is stored in the diagnosis database 604.

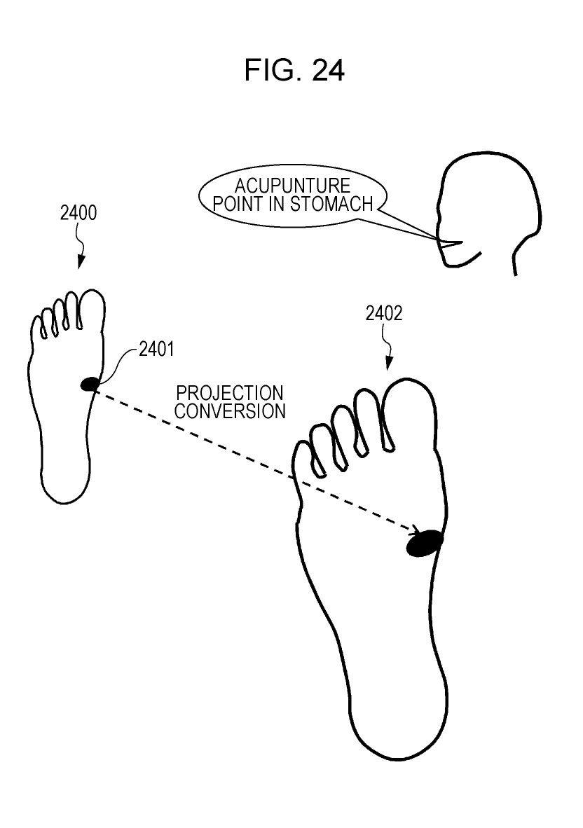

When a foot acupuncture point 2401 corresponding to a portion which is designated by a user (for example, stomach) is found by referring to a foot acupuncture point table 2400 in the diagnosis database 604, the diagnosis unit 603 performs a projection conversion of a location thereof on the outline of the sole of the foot 2402 (on a field of vision of the user) which is extracted in the feature amount extraction unit 602 (refer to FIG. 24).

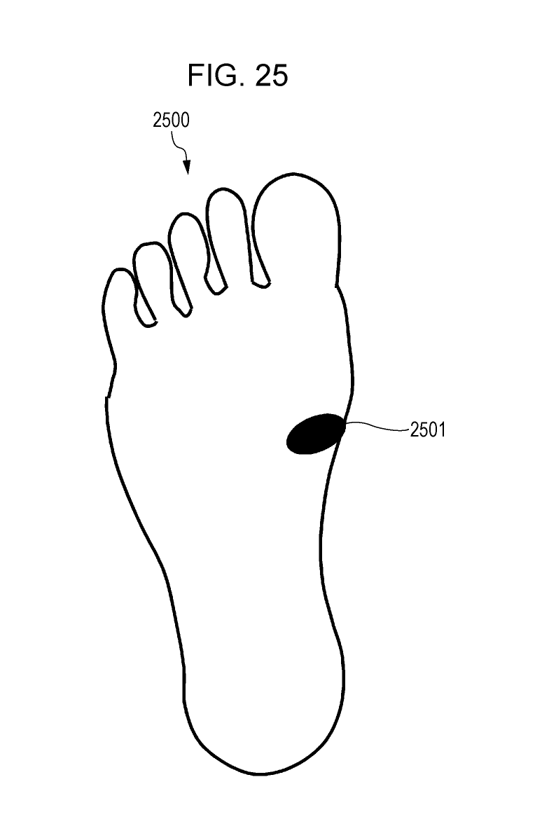

In addition, the compositing unit 605 displays and outputs a foot acupuncture point 2501 which is obtained as a diagnosis result onto the display unit 509 by overlapping the position with an image 2500 of the original sole of the foot (refer to FIG. 25). Accordingly, the user is able to accurately understand the acupuncture point, and to accurately perform massage, or a finger-pressure treatment without remembering, or referring to the acupuncture point table.

In addition, only the acupuncture point on the sole of the foot is described in FIGS. 23 to 25, however, it is also possible to apply the technology which is disclosed in the specification to other portions such as acupuncture points on a palm, acupuncture points on the shoulder, and acupuncture points on the back.

(1) An image display device which is used by being mounted on the head or a face includes an image display unit which displays an image; an image input unit which inputs an image; a judging unit which judges an image which is input to the image input unit, or obtains a judging result with respect to the input image; and a control unit which controls the image display unit based on the judging result of the judging unit.

(2) The image display device which is described in (1) further including a camera, in which the image input unit inputs an image which is photographed by the camera.

(3) The image display device which is described in (2), in which the camera photographs a gaze direction of a user, or at least a part of a body of the user.

(4) The image display device which is described in (1) further including a storage unit which stores an image, and in which the image input unit inputs an image which is read out from the storage unit.

(5) The image display device which is described in (1) further including a communication unit which communicates with an external device, and in which the image input unit inputs an image which is obtained from the external device through the communication unit.

(6) The image display device which is described in (1), in which the control unit displays an image denoting the judging result by overlapping the image with a corresponding location of the image which is displayed by the image display unit.

(7) The image display device which is described in (1), in which the image input unit inputs an image which is displayed by the image display unit, the judging unit judges a specified portion in the input image, and the control unit displays the judging result by overlapping the result with a location corresponding to the specified portion in the image which is displayed by the image display unit.

(8) The image display device which is described in (1), in which the image display unit displays the image in a see-through mode, the image input unit inputs a photographed image in which the gaze direction of a user is photographed using a camera, the judging unit judges a specified portion in the photographed image, and the control unit displays the judging result on the image display unit so that the judging result is overlapped with the specified portion on a field of vision of the user.

(9) The image display device which is described in (1), in which the image display unit displays the photographed image in which the gaze direction of the user is photographed using the camera, the image input unit inputs the photographed image, the judging unit judges the specified portion in the photographed image, and the control unit displays the judging result by overlapping the result with the specified portion in the photographed image.

(10) The image display device which is described in (1) further including a storage unit which stores a judging result of the judging unit, or an image which is controlled based on the judging result.

(11) The image display device which is described in any one of (6) to (9), in which the judging unit performs a diagnosis based on characteristics of a specified portion in the input image, and the control unit displays a result of the diagnosis by overlapping the result with a location corresponding to the specified portion in an image which is displayed by the image display unit.

(12) The image display device which is described in any one of (6) to (9), in which the judging unit performs palm reading with respect to palm lines on a palm which is included in the input image, and the control unit displays a result of the palm reading by overlapping the result with a location corresponding to the palm lines in an image which is displayed by the image display unit.

(13) The image display device which is described in (12) further including a feature amount extraction unit which extracts palm lines from a palm which is included in the input image, and in which the judging unit performs palm reading based on the palm lines which are extracted by the feature amount extraction unit.

(14) The image display device which is described in (13), in which the control unit displays the palm lines which are extracted by the feature amount extraction unit by overlapping the palm lines with an image which is displayed by the image display unit.

(15) The image display device which is described in (12), in which the image input unit inputs an image including left and right palms, and the judging unit performs palm reading on the left and right palms from the input image.

(16) The image display device which is described in (15) further including a feature amount extraction unit which extracts palm lines from a palm which is included in the input image, and in which the control unit displays palm lines which are extracted from one of the left and right palms by overlapping the palm lines with palm lines on the other palm, by inverting the palm lines from left to right.

(17) The image display device which is described in any one of (6) to (9), in which the judging unit diagnoses a palm hill of a base of at least one finger of a hand which is included in the input image, and the control unit displays a result of the diagnosis by overlapping the result with a location corresponding to the palm hill in an image which is displayed by the image display unit.

(18) The image display device which is described in any one of (6) to (9), in which the judging unit diagnoses a length of at least one finger of the hand which is included in the input image, and the control unit displays a result of the diagnosis by overlapping the result with a corresponding finger in an image which is displayed by the image display unit.

(19) The image display device which is described in any one of (6) to (9), in which the judging unit performs face reading with respect to a face image which is included in the input image, and the control unit displays a result of the face reading by overlapping the result with a location which becomes grounds of the face reading in an image which is displayed by the image input unit.

(20) The image display device which is described in any one of (6) to (9), in which the judging unit performs a skin diagnosis with respect to the face image which is included in the input image, and the control unit displays a result of the skin diagnosis by overlapping the result with a location which becomes grounds of the skin diagnosis in an image which is displayed by the image display unit.

(21) The image display device which is described in any one of (6) to (9), in which the judging unit specifies a position of an acupuncture point from a body of a person which is included in the input photographed image, and the control unit displays the specified position of the acupuncture point by overlapping the position with a corresponding location in an image which is displayed by the image display unit.

(22) An image display method which displays an image in an image display device which is used by being mounted on the head or a face, the method including inputting of an image; judging an image which is input in the inputting of the image, or obtaining a judging result with respect to the input image; and controlling an image which will be displayed based on the judging result of the judging.

(23) A computer program in which processing for displaying an image in a head-mounted image display device, or a face-mounted image display device is described in a computer-readable format, the program causing a computer to function as an image display unit which displays an image; an image input unit which inputs an image; a judging unit which judges an image which is input to the image input unit, or obtains a judging result with respect to the input image; and a control unit which controls an image which will be displayed based on the judging result of the judging unit.

It should be understood by those skilled in the art that various modifications, combinations, sub-combinations and alterations may occur depending on design requirements and other factors insofar as they are within the scope of the appended claims or the equivalents thereof.

What is claimed is:

1. An image display device which is used by being mounted on the head or a face comprising:
an image display unit which displays an image;
an image input unit which inputs an image;
a judging unit which judges an image which is input to the image input unit, or obtains a judging result with respect to the input image; and
a control unit which controls the image display unit based on the judging result of the judging unit.

2. The image display device according to claim 1, further comprising:
a camera,
wherein the image input unit inputs an image which is photographed by the camera.

3. The image display device according to claim 2,
wherein the camera photographs a gaze direction of a user, or at least a part of a body of the user.

4. The image display device according to claim 1, further comprising:
a storage unit which stores an image,
wherein the image input unit inputs the image which is read out from the storage unit.

5. The image display device according to claim 1, further comprising:
a communication unit which communicates with an external device,
wherein the image input unit inputs an image which is obtained from the external device through the communication unit.

6. The image display device according to claim 1,
wherein the image display unit displays the image in a see-through mode,
wherein the image input unit inputs a photographed image in which the gaze direction of a user is photographed using a camera,
wherein the judging unit judges a specified portion in the photographed image, and
wherein the control unit displays the judging result on the image display unit so that the judging result is overlapped with the specified portion on a field of vision of the user.

7. The image display device according to claim 1,
wherein the image display unit displays a photographed image in which a gaze direction of a user is photographed using a camera,
wherein the image input unit inputs the photographed image,
wherein the judging unit judges a specified portion in the photographed image, and
wherein the control unit displays the judging result by overlapping the result with the specified portion in the photographed image.

8. The image display device according to claim 1, further comprising:
a storage unit which stores the judging result of the judging unit, or an image which is controlled based on the judging result.

9. The image display device according to claim 6,
wherein the judging unit performs a diagnosis based on characteristics of a specified portion in the input image, and
wherein the control unit displays a result of the diagnosis by overlapping the result with a location corresponding to the specified portion in an image which is displayed by the image display unit.

10. The image display device according to claim 6,
wherein the judging unit performs palm reading with respect to palm lines on a palm which are included in the input image, and
wherein the control unit displays a result of the palm reading by overlapping the result with a location corresponding to the palm lines in the image which is displayed by the image display unit.

11. The image display device according to claim 10, further comprising:
a feature amount extraction unit which extracts palm lines from a palm which are included in the input image,
wherein the judging unit performs palm reading based on the palm lines which are extracted by the feature amount extraction unit.

12. The image display device according to claim 11,
wherein the control unit displays the palm lines which are extracted by the feature amount extraction unit by overlapping the palm lines with an image which is displayed by the image display unit.

13. The image display device according to claim 10,
wherein the image input unit inputs an image including left and right palms, and
wherein the judging unit performs palm reading on the left and right palms from the input image.

14. The image display device according to claim 13, further comprising:
the feature amount extraction unit which extracts palm lines from a palm which are included in the input image,
wherein the control unit displays palm lines which are extracted from one of the left and right palms by overlapping the palm lines with palm lines on the other palm, by inverting the palm lines from left to right.

15. The image display device according to claim 6,
wherein the judging unit diagnoses a palm hill of a base of at least one finger of a hand which is included in the input image, and
wherein the control unit displays a result of the diagnosis by overlapping the result with a location corresponding to the palm hill in an image which is displayed by the image display unit.

16. The image display device according to claim 6,
wherein the judging unit diagnoses a length of at least one finger of a hand which is included in the input image, and
wherein the control unit displays a result of the diagnosis by overlapping the result with a corresponding finger in an image which is displayed by the image display unit.

17. The image display device according to claim 6,
wherein the judging unit performs face reading with respect to a face image which is included in the input image, and
wherein the control unit displays a result of the face reading by overlapping the result with a location which becomes grounds of the face reading in an image which is displayed by the image input unit.

18. The image display device according to claim 6,
wherein the judging unit performs a skin diagnosis with respect to the face image which is included in the input image, and
wherein the control unit displays a result of the skin diagnosis by overlapping the result with a location which becomes grounds of the skin diagnosis in an image which is displayed by the image display unit.

19. The image display device according to claim 6,
wherein the judging unit specifies a position of an acupuncture point from a body of a person which is included in the input photographed image, and
wherein the control unit displays the specified position of the acupuncture point by overlapping the position with a corresponding location in an image which is displayed by the image display unit.

20. An image display method which displays an image in an image display device which is used by being mounted on the head or a face, the method comprising:
inputting an image;
judging an image which is input in the inputting of the image, or obtaining a judging result with respect to the input image; and
controlling an image which will be displayed based on the judging result of the judging.
